(19) United States
(12) Patent Application Publication
(10) Pub. No.: US 2025/0263104 A1
(43) Pub. Date: Aug. 21, 2025

(54) VEHICLE DRIVING CONTROL APPARATUS

(71) Applicants: Hyundai Motor Company, Seoul (KR); Kia Corporation, Seoul (KR)

(72) Inventor: Eun Sik KIM, Gwangmyeong-si (KR)

(21) Appl. No.: 18/800,930

(22) Filed: Aug. 12, 2024

(30) Foreign Application Priority Data
Feb. 21, 2024 (KR) 10-2024-0025151

(51) Int. Cl. B62D 1/04; B60K 20/06; B60K 26/02; B60K 35/60; B60Q 3/283; B60Q 3/70; B60T 7/10; B62D 5/00; G05G 5/05

(52) U.S. Cl. CPC B62D 1/046; B60K 20/06; B60K 26/02; B60K 35/60; B60Q 3/283; B60Q 3/70; B60T 7/10; B62D 5/001; G05G 5/05; B60K 2026/028; B60K 2360/782; B60K 2360/816; G05G 2505/00

(57) ABSTRACT

A vehicle driving control apparatus has a modular configuration integrating a steering wheel, an acceleration control system, a braking control system, a shift control system, an emergency light control system, a direction indication control system, and a display into one system. The vehicle driving control apparatus provides a manual driving mode and an autonomous driving mode. The steering wheel is configured to be coupled to a vehicle panel in the manual driving mode and to be separated from the vehicle panel in the autonomous driving mode.

### CROSS-REFERENCE TO THE RELATED APPLICATION

This application claims priority from Korean Patent Application No. 10-2024-0025151, filed on Feb. 21, 2024, in the Korean Intellectual Property Office, the disclosure of which is incorporated herein by reference in its entirety.

### TECHNICAL FIELD

The present disclosure relates to a vehicle driving control apparatus, and more particularly to technology related to a vehicle driving control apparatus having a modular configuration obtained by integrating control systems for steering, acceleration, braking, and shifting into one system, in which the vehicle driving control apparatus is capable of being mounted on and removed from a vehicle.

### BACKGROUND

An autonomous vehicle is a smart vehicle equipped with autonomous driving technology that enables the vehicle to reach a desired destination of a driver while sensing environmental conditions without direct control of the driver, such as driver manipulation of a steering wheel, an accelerator pedal, or a brake pedal.

When autonomous driving technology is widely and generally applied to a vehicle, a driver may select one of a manual driving mode and an autonomous driving mode. Here, a driver directly drives a vehicle in the manual driving mode, and a vehicle is capable of reaching a desired destination of a driver without driver operation of the vehicle in the autonomous driving mode.

In some cases, an autonomous vehicle may include a plurality of control systems for steering, acceleration, braking, and shifting. In this case, these control systems are not integrated into one system, which may cause inconvenience in use.

In some cases, a driving control system may be fixed to a vehicle, which may also cause inconvenience in use.

The information disclosed in this Background of the Disclosure section is only for enhancement of understanding of the general background of the disclosure, and should not be taken as an acknowledgement or any form of suggestion that this information forms the related art already known to a person skilled in the art.

### SUMMARY

Therefore, the present disclosure has been made in view of the above problems, and it is an object of the present disclosure to provide a vehicle driving control apparatus having a modular configuration obtained by integrating control systems for steering, acceleration, braking, and shifting into one system, in which the vehicle driving control apparatus is configured to reduce weight and costs by reducing the number of parts and to maximally reduce the size of a layout area for an installation space, thereby making it possible to maximally improve utilization of a vehicle interior space.

It is another object of the present disclosure to provide a vehicle driving control apparatus capable of being mounted on and removed from a vehicle, in which the vehicle driving control apparatus is mounted on the vehicle in a manual driving mode and is removed from the vehicle in an autonomous driving mode, thereby making it possible to efficiently improve utilization of a vehicle interior space.

It is a further object of the present disclosure to provide a vehicle driving control apparatus having a configuration in which a display maintains, regardless of a steering operation, a fixed position thereof without rotation and is not blocked by a steering control system, thereby making it possible to use the display more safely and conveniently.

In accordance with the present disclosure, the above and other objects can be accomplished by the provision of a vehicle driving control apparatus including a steering wheel gripped by a hand of a driver, wherein the driver rotates the steering wheel to perform a steering operation, a first installation part and a second installation part respectively disposed, relative to the steering wheel in a neutral state, at one upper end corner portion of the steering wheel and the other upper end corner portion thereof, and an acceleration control system and a braking control system provided at the first installation part.

The vehicle driving control apparatus may further include an emergency light control system and a direction indication control system provided at the second installation part.

The vehicle driving control apparatus may further include a display provided at a center portion of the steering wheel and configured to maintain a fixed state thereof during rotation of the steering wheel, wherein the display may be disposed closer to the driver than the steering wheel so as to prevent a screen from being blocked by the steering wheel.

The vehicle driving control apparatus may further include a shift control system disposed on the display.

The steering wheel may include handle parts respectively provided on left and right sides of the steering wheel and symmetrically formed on the left and right sides thereof, wherein each of the handle parts may have a circular arc shape protruding outwards and is gripped by the hand of the driver, an upper connection part configured to connect upper ends of the handle parts respectively provided on the left and right sides of the steering wheel, wherein the upper connection part may have the first installation part and the second installation part respectively provided at opposite corner portions thereof respectively connected to the handle parts, a lower connection part configured to connect lower ends of the handle parts respectively provided on the left and right sides of the steering wheel, and a center part provided at a center portion between the handle parts respectively provided on the left and right sides of the steering wheel and configured to connect the upper connection part to the lower connection part, wherein the center part may allow the display to pass therethrough.

The braking control system may be disposed on a left side of the acceleration control system and may be formed to have a larger external size than an external size of the acceleration control system, and a height at which the braking control system protrudes outwards from the first installation part may be greater than a height at which the acceleration control system protrudes outwards from the first installation part.

The direction indication control system more frequently used than the emergency light control system may be disposed below the emergency light control system so as to be located close to the hand of the driver.

The first installation part and the second installation part may respectively have inclined front surfaces, wherein each of the inclined front surfaces may have an upper end protruding farther in a direction toward the driver than a lower end.

The upper connection part and an inner surface of the first installation part may form a first groove having an acute angle, the first groove may allow a thumb of a right hand of the driver to be inserted thereinto so as to perform the steering operation, the upper connection part and an inner surface of the second installation part may form a second groove having an acute angle, and the second groove may allow a thumb of a left hand of the driver to be inserted thereinto so as to perform the steering operation.

The first installation part may have an outer surface protruding farther outwards than the right handle part of the steering wheel so as to form a third groove between the outer surface of the first installation part and the right handle part, the third groove may allow an index finger of a right hand of the driver to be inserted thereinto so as to perform the steering operation, the second installation part may have an outer surface protruding farther outwards than the left handle part of the steering wheel so as to form a fourth groove between the outer surface of the second installation part and the left handle part, and the fourth groove may allow an index finger of a left hand of the driver to be inserted thereinto so as to perform the steering operation.

The vehicle driving control apparatus may further include a first connector formed to be coupled with a portion of the display penetrating the steering wheel, a second connector fixed to a vehicle panel and detachably coupled to the first connector, and a locking guide movably provided on the vehicle panel and configured to lock and unlock the first connector and the second connector.

The vehicle driving control apparatus may further include a first permanent magnet provided at the steering wheel and disposed to face the first connector, and a first PCB provided at the first connector and disposed to face the first permanent magnet, wherein the first PCB may generate, during the rotation of the steering wheel, a steering signal by recognizing a signal of the first permanent magnet.

The vehicle driving control apparatus may further include a steering spring having opposite ends respectively connected to the steering wheel and the first connector and configured to provide return force during the rotation of the steering wheel.

The first connector may have a connector protrusion formed to protrude from an end thereof, the connector protrusion may penetrate a connector hole formed in the vehicle panel and may be inserted into a connector groove formed in the second connector, and when the locking guide is coupled to the connector protrusion in a state in which the connector protrusion is inserted into the connector groove, the first connector and the second connector may be prevented from being separated from each other so as to maintain a coupled state therebetween.

The locking guide may be installed to slidably move, by using a guide spring, upwards and downwards relative to the vehicle panel, the connector hole may be partially covered by the locking guide and is fully opened only when the locking guide moves, and the connector protrusion may penetrate, only when the connector hole is fully opened, the connector hole so as to be inserted into and coupled to the connector groove.

The locking guide may be installed to slidably move upwards and downwards relative to the vehicle panel and may have wing parts provided at an end thereof and formed to extend in a longitudinal direction thereof, the connector protrusion may have locking grooves respectively formed in side surfaces thereof and configured to allow the wing parts to be respectively inserted thereinto, wherein each of the locking grooves may be formed to extend in a movement direction of the locking guide, and when the wing parts are respectively inserted into the locking grooves by movement of the locking guide, the first connector and the second connector may be prevented from being separated from each other so as to maintain the coupled state therebetween.

The locking guide may further have a locking hook formed thereon, the first connector may have a hook groove formed therein and configured to allow the locking hook to be inserted thereinto, and the locking hook and the hook groove may be coupled to each other when the wing parts and the locking grooves are coupled to each other, thereby strengthening coupling force between the first connector and the second connector.

The first connector may have an arc-shaped guide protrusion provided at one end thereof and formed to protrude in a longitudinal direction thereof, the vehicle panel may have an arc-shaped guide groove formed therein and configured to allow the guide protrusion to be inserted thereinto, and the guide protrusion and the guide groove may be coupled to each other when the connector protrusion penetrates the connector hole and is coupled to the connector groove, thereby strengthening the coupling force between the first connector and the second connector.

The display may have a protrusion provided on a surface thereof, the surface facing a front side of a vehicle, and the protrusion of the display may penetrate the center portion of the steering wheel so as to be coupled with the first connector in a male and female coupling manner.

Each of the wing parts may have a lower end formed to have a larger cross-sectional thickness than a cross-sectional thickness of an upper end, and the cross-sectional thickness gradually may become thinner from the lower end to the upper end.

### BRIEF DESCRIPTION OF THE DRAWINGS

The above and other objects, features and other advantages of the present disclosure will be more clearly understood from the following detailed description taken in conjunction with the accompanying drawings.

FIG. 1 is a view showing an example of a vehicle driving control apparatus coupled to a vehicle panel.

FIG. 2 is a view showing an example state in which the vehicle driving control apparatus is separated from the vehicle panel.

FIG. 3 is a view showing the vehicle driving control apparatus shown in FIG. 2 and viewed from the front side.

FIG. 4 and FIG. 5 are exploded views of the vehicle driving control apparatus.

FIG. 6 is a view showing a state in which a first connector is separated from the vehicle driving control apparatus shown in FIG. 3.

FIG. 7 is a plan cross-sectional view of the vehicle driving control apparatus shown in FIG. 3.

FIG. 8 and FIG. 9 are right and left side views of the vehicle driving control apparatus.

FIG. 10 and FIG. 11 are views each showing a state in which a driver grips a steering wheel with the right and left hands.

FIG. 12 is a view showing a direction indication control system according to the present disclosure.

FIG. 13 is a view showing an acceleration control system and a braking control system according to the present disclosure.

FIG. 14, FIG. 15, FIG. 16, FIG. 17, and FIG. 18 are views each showing a coupling structure of a first connector, a second connector, and a locking guide according to the present disclosure.

FIG. 19 is a view showing a state in which the steering wheel is coupled to the first connector shown in FIG. 18.

### DETAILED DESCRIPTION

Hereinafter, the present disclosure will be described in detail through one or more implementations thereof with reference to the accompanying drawings. Wherever possible, the same reference numbers will be used throughout the drawings to refer to the same or like parts, and redundant descriptions thereof will be omitted.

In the present disclosure, a unit or a control unit included in the names of a motor control unit (MCU), a hybrid control unit (HCU), and the like is only a term widely used in the naming of a controller configured to control a specific function of a vehicle, and does not mean a generic functional unit.

In order to control various functions, a controller may include a communication apparatus configured to communicate with another controller or a sensor, a memory configured to store a control system, a logical command, and input/output information, and one or more processors configured to perform determination, calculation, and the like to control a corresponding function.

Hereinafter, a vehicle driving control apparatus of the present disclosure will be described with reference to the attached drawings.

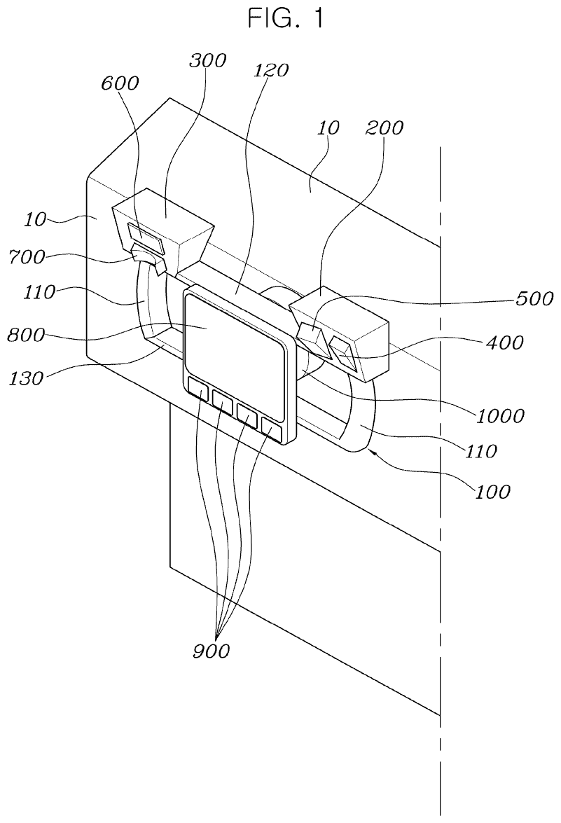

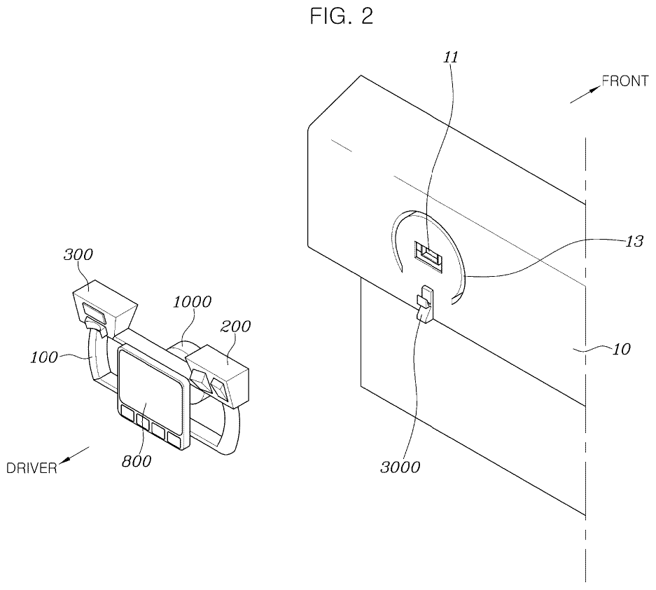

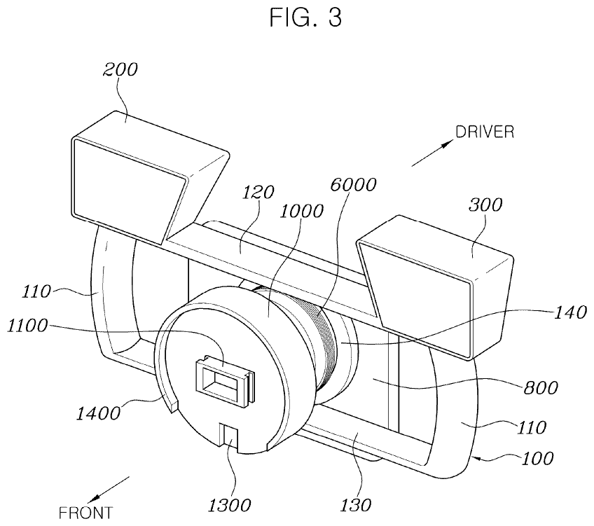

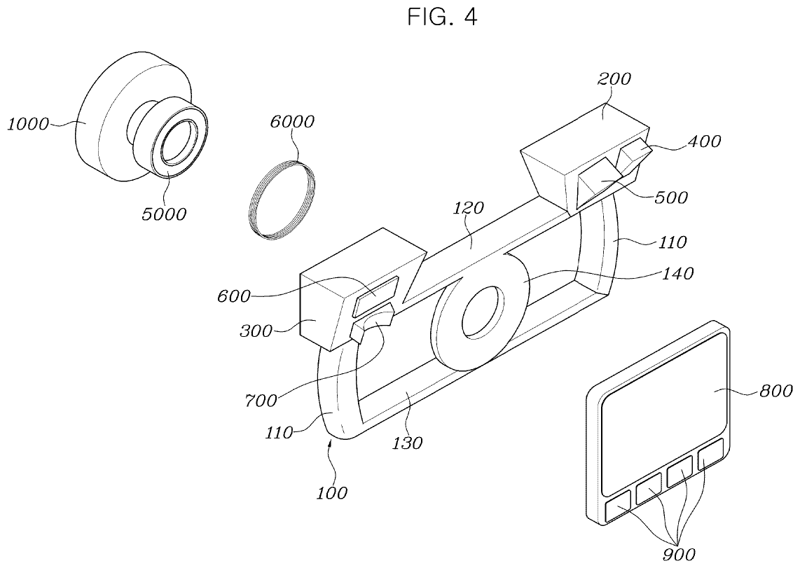

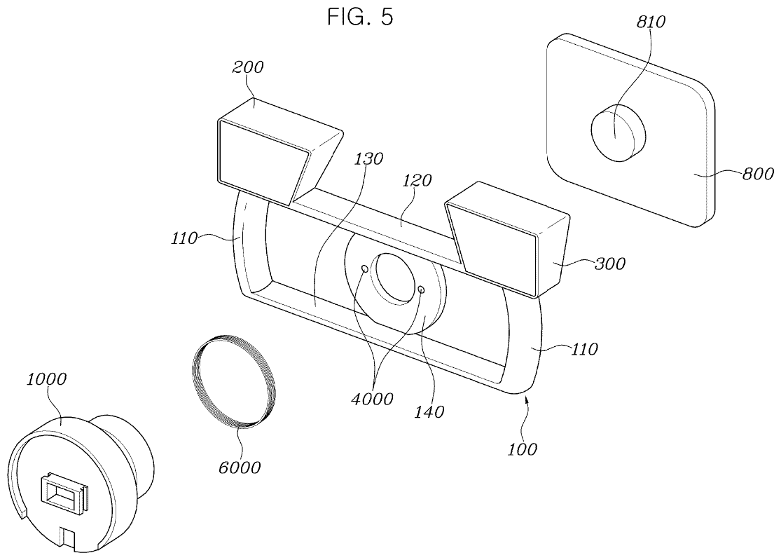

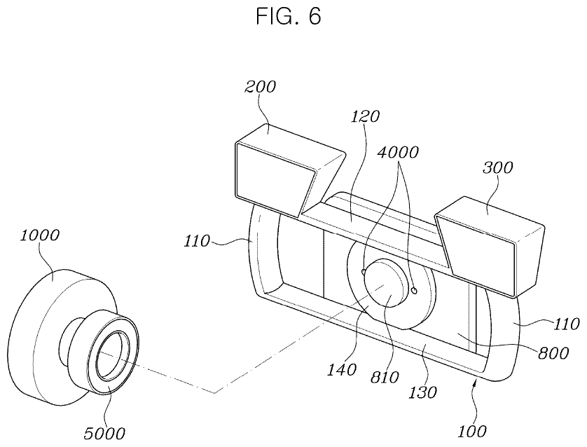

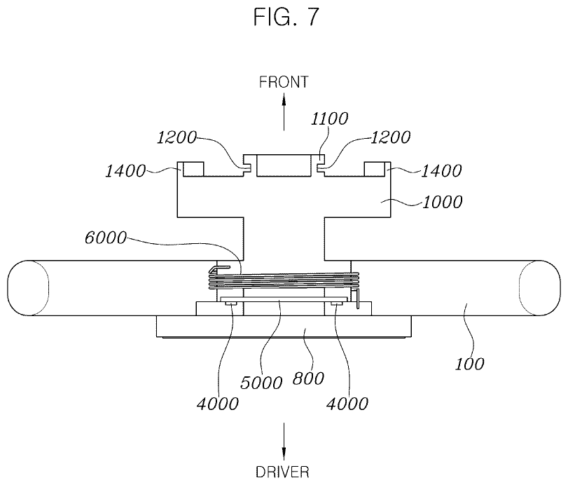

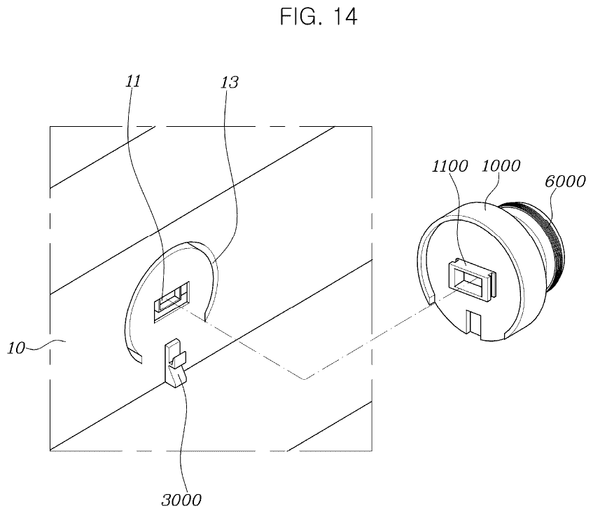

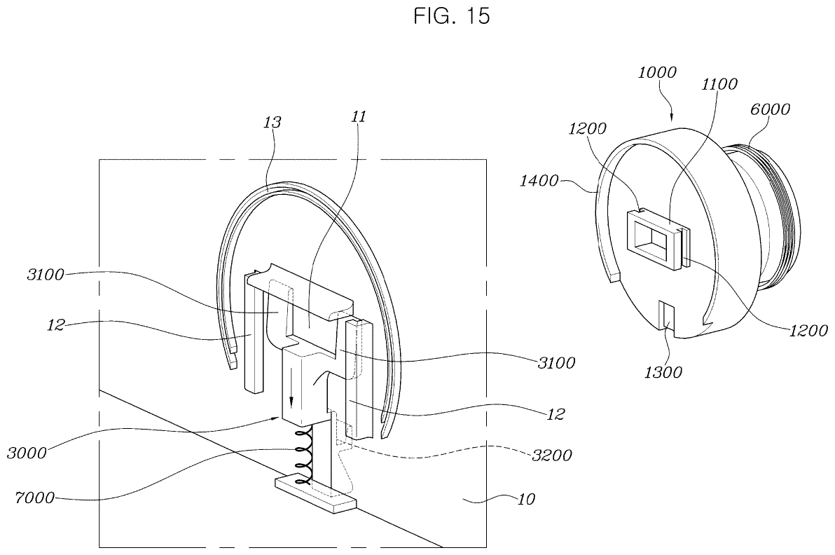

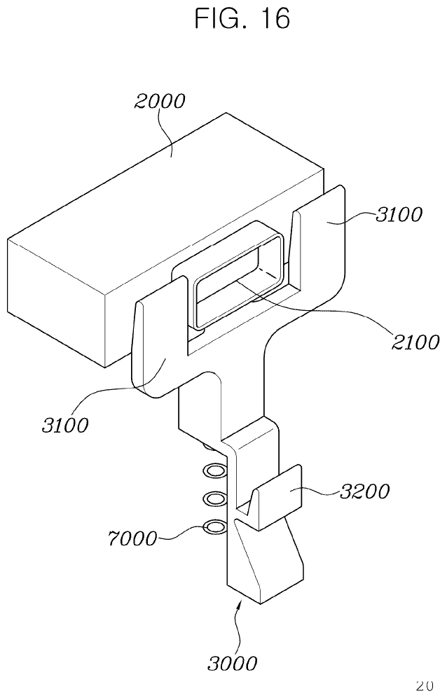

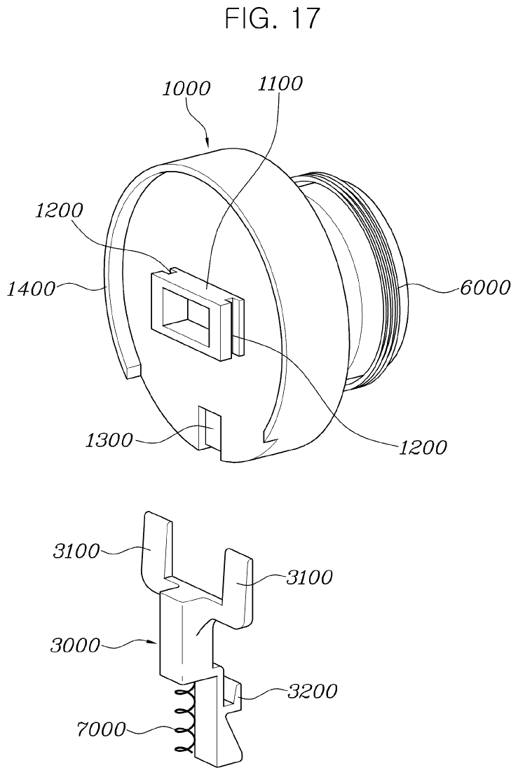

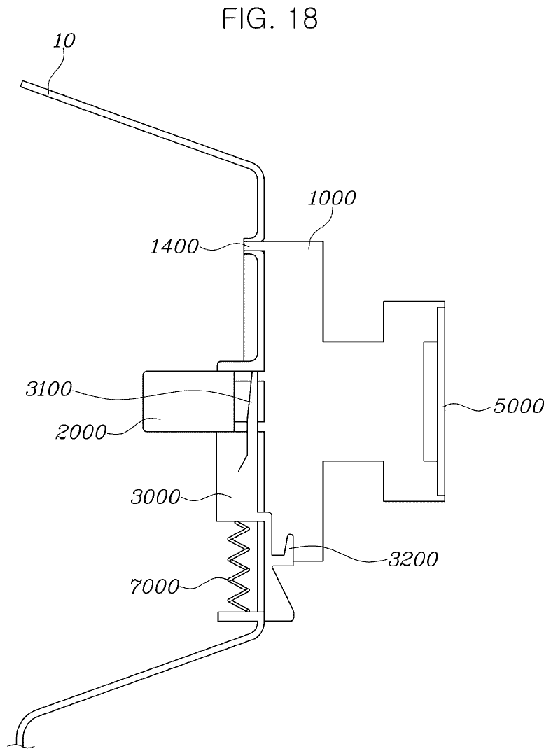

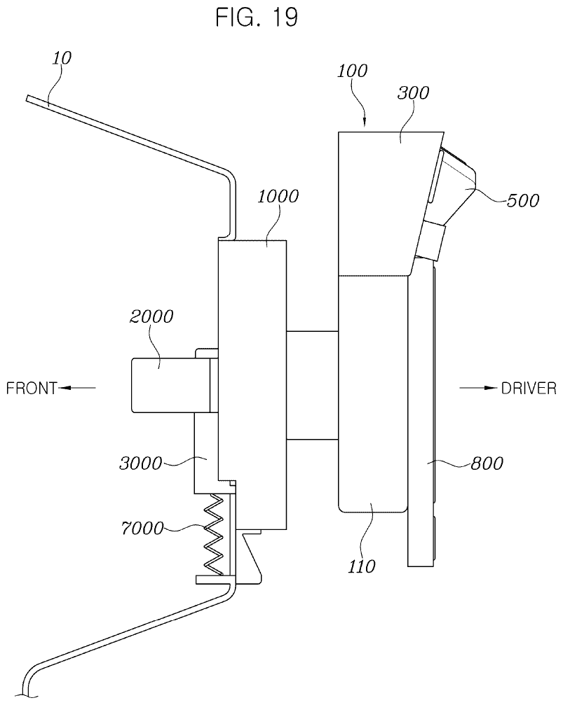

In some implementations, as shown in FIGS. 1 to 19, the vehicle driving control apparatus according to the present disclosure may include a steering wheel 100 gripped by the hand of a driver, in which the driver rotates the steering wheel 100 to perform a steering operation, a first installation part 200 and a second installation part 300 respectively disposed, relative to the steering wheel 100 in the neutral state, at one upper end corner portion of the steering wheel 100 and the other upper end corner portion of the steering wheel 100, an acceleration control system 400 and a braking control system 500 provided at the first installation part 200, and an emergency light control system 600 and a direction indication control system 700 provided at the second installation part 300.

The steering wheel 100 is installed in a rotatable structure on a vehicle panel 10, and the driver may perform the steering operation by gripping the steering wheel 100 with the hand and rotating the same clockwise or counterclockwise.

The vehicle panel 10 refers to an interior panel of a vehicle, and may be a center fascia panel.

The steering wheel 100 may be mounted on the vehicle panel 10 when the steering wheel 100 is used or may be removed from the vehicle panel 10 when the steering wheel 100 is not used.

That is, in a manual driving mode, the steering wheel 100 is used by being mounted on the vehicle panel 10, and in an autonomous driving mode, the steering wheel 100 may be removed from the vehicle panel 10, thereby efficiently improving utilization of a vehicle interior space in the autonomous driving mode.

When the steering wheel 100 is in the neutral state, the first installation part 200 and the second installation part 300 may be provided to protrude in the radial direction and may be respectively disposed at the upper end corner portion on the right side of the steering wheel 100 and the upper end corner portion on the left side thereof.

The neutral state of the steering wheel 100 refers to a state in which the driver does not rotate the steering wheel 100 clockwise or counterclockwise. In this state, vehicle wheels may be arranged to face forwards.

The acceleration control system 400 and the braking control system 500 may be installed at the first installation part 200, and the emergency light control system 600 and the direction indication control system 700 may be installed at the second installation part 300.

In a state in which a right hand 20 of the driver and a left hand 30 of the driver respectively grip the right side and the left side of the steering wheel 100, the acceleration control system 400 and the braking control system 500 may be operated by a thumb 21 of the right hand 20, and the emergency light control system 600 and the direction indication control system 700 may be operated by a thumb 31 of the left hand 30.

Each of the acceleration control system 400 and the braking control system 500 may be formed as a button type, and the driver may operate the acceleration control system 400 and the braking control system 500 by pressing the same with the thumb 21 of the right hand 20.

The emergency light control system 600 may be formed as an ON-and-OFF type switch, and the direction indication control system 700 may be formed as a three-stage rocker switch.

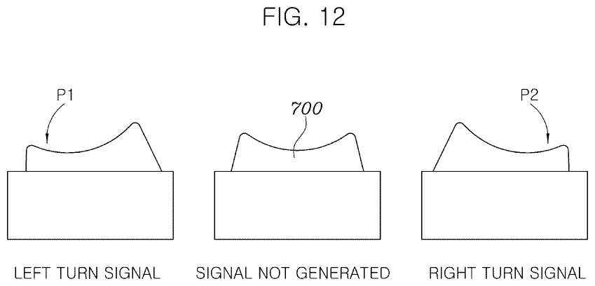

Referring to FIG. 12, the direction indication control system 700 that is formed as the three-stage rocker switch does not generate a direction indication signal when the switch is not operated (neutral position). When a left side of the switch is pressed as shown by an arrow P1, a left turn signal may be generated, and when a right side of the switch is pressed as shown by an arrow P2, a right turn signal may be generated.

In addition, the vehicle driving control apparatus according to the present disclosure may further include a display 800 provided at a center portion of the steering wheel 100 and configured to maintain a fixed state thereof during rotation of the steering wheel 100, in which the display 800 is disposed closer to the driver than the steering wheel 100 so as to prevent a screen from being blocked by the steering wheel 100.

When the steering wheel 100 is rotated by the steering operation, the display 800 is not rotated and maintains a fixed position thereof. Particularly, the display 800 is disposed closer to the driver than the steering wheel 100, thereby preventing the screen from being blocked by the steering wheel 100. In this manner, the driver may look at the display 800 more stably and comfortably.

Additionally, the vehicle driving control apparatus according to the present disclosure may further include a shift control system 900 disposed on the display 800.

For example, the shift control system 900 may be formed as a button and may be disposed below the display 800 or may be disposed on one side of the display 800.

As another example, the shift control system 900 may be formed as a capacitive touchscreen so as to be integrated with the display 800.

The shift control system 900 may generate, when operated by the driver, a shift stage signal of any one of the P stage, the R stage, the N stage, and the D stage.

The vehicle driving control apparatus according to the present disclosure has a modular configuration in which the steering wheel 100, the acceleration control system 400, the braking control system 500, the emergency light control system 600, the direction indication control system 700, the display 800, and the shift control system 900 are integrated into one system. Through the modular configuration, it is possible to reduce the number of parts and to achieve weight reduction and cost reduction. In particular, the size of a layout area for an installation space may be maximally reduced, thereby having an effect of maximally improving utilization of a vehicle interior space.

The steering wheel 100 may include handle parts 110 respectively provided on the left and right sides thereof and formed to be symmetrical to the left and right sides thereof, in which each of the handle parts 110 has a circular arc shape protruding outwards and is gripped by the hand of a driver, an upper connection part 120 configured to connect the upper ends of the handle parts 110 respectively provided on the left and right sides of the steering wheel 100, in which the upper connection part 120 has the first installation part 200 and the second installation part 300 respectively provided at opposite corner portions thereof respectively connected to the handle parts 110, a lower connection part 130 configured to connect the lower ends of the handle parts 110 respectively provided on the left and right sides of the steering wheel 100, and a center part 140 provided at a center portion between the handle parts 110 respectively provided on the left and right sides of the steering wheel 100 and configured to connect the upper connection part 120 to the lower connection part 130, in which the center part 140 allows the display 800 to pass therethrough.

The steering wheel 100 according to the present disclosure is configured to form a small-sized appearance only using the handle parts 110 respectively provided on the left and right sides of the steering wheel 100, the upper connection part 120, the lower connection part 130, and the center part 140, thereby having an effect of being light in weight and securing strength and rigidity as compared with other steering wheels.

In particular, each of the handle parts 110 respectively provided on the left and right sides of the steering wheel 100 has a circular arc shape protruding outwards, thereby providing a larger space defined between the center part 140 and the circular-arc-shaped handle parts 110 than a space defined between the center part 140 and straight-shaped handle parts. Through this structural configuration, when gripping the handle parts 110, a driver may grip the handle parts 110 more comfortably without interfering with the center part 140.

According to the present disclosure, the acceleration control system 400 and the braking control system 500 are provided at the first installation part 200, the acceleration control system 400 is disposed on the right side of the braking control system 500, and the braking control system 500 is disposed on the left side of the acceleration control system 400. In particular, the braking control system 500 may have a larger external size than that of the acceleration control system 400.

In a state in which the driver grips the right handle part 110 of the steering wheel 100 with the right hand 20, the driver may operate the acceleration control system 400 and the braking control system 500 with the thumb 21 of the right hand 20.

At this time, it is desirable to position the braking control system 500 closer to the thumb 21 of the right hand 20 of the driver than the acceleration control system 400, thereby making it possible to perform an emergency operation of the braking control system 500. To this end, in a structure in which the acceleration control system 400 and the braking control system 500 are arranged at the left and right sides of the first installation part 200, it is desirable to dispose the braking control system 500 on the left side of the acceleration control system 400 so as to perform an emergency operation by the driver.

In some implementations, the braking control system 500 may have a larger external size than that of the acceleration control system 400 for smooth and safe operation by the driver. In particular, the left and right widths of the braking control system 500 may be larger than those of the acceleration control system 400, but the present disclosure is not limited thereto.

According to the present disclosure, a height at which the braking control system 500 protrudes outwards from the first installation part 200 (a height at which the braking control system 500 protrudes in the direction toward the driver) is set to be greater than a height at which the acceleration control system 400 protrudes outwards from the first installation part 200 (a height at which the acceleration control system 400 protrudes in the direction toward the driver). Through this structural configuration, the driver may easily perform an emergency operation of the braking control system 500 with the thumb 21 of the right hand 20, and maloperation may be prevented by a height difference between the acceleration control system 400 and the braking control system 500.

According to the present disclosure, the second installation part 300 is provided with the emergency light control system 600 and the direction indication control system 700. In the case of the emergency light control system 600 and the direction indication control system 700, the direction indication control system 700 which is relatively frequently used may be disposed below the emergency light control system 600 so as to be positioned close to the driver's hand.

In a state in which the driver grips the left handle part 110 of the steering wheel 100 with the left hand 30, the driver may operate the emergency light control system 600 and the direction indication control system 700 with the thumb 31 of the left hand 30.

In this case, it is desirable to position the frequently used direction indication control system 700 closer to the thumb 31 of the driver's left hand 30 than the emergency light control system 600. To this end, in the second installation part 300 having the emergency light control system 600 and the direction indication control system 700 disposed in the vertical direction, the direction indication control system 700 may be disposed below the emergency light control system 600.

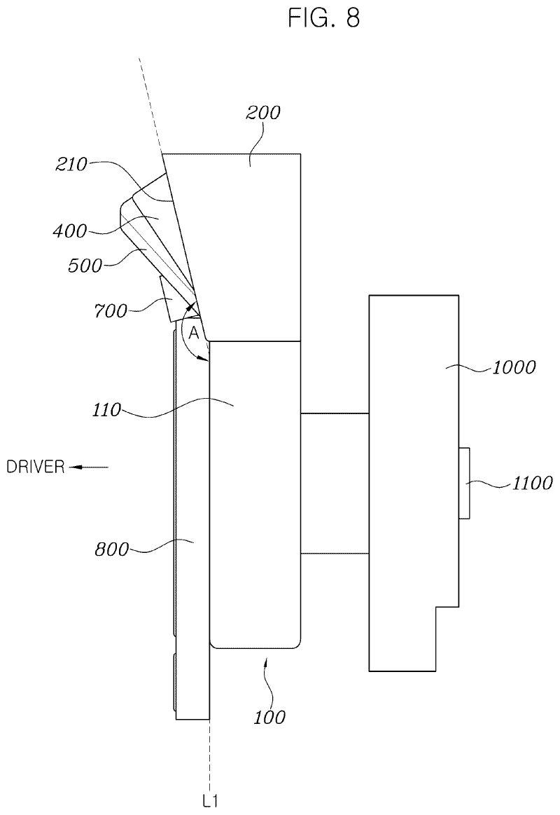

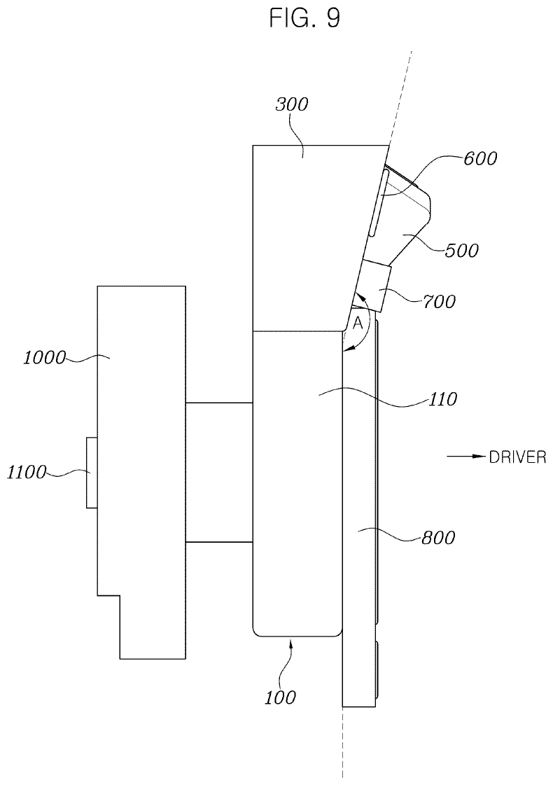

Referring to FIGS. 8 and 9, a front surface 210 of the first installation part 200 and a front surface 310 of the second installation part 300 according to the present disclosure are respectively formed to have inclined surfaces such that the upper ends of the front surface 210 and the front surface 310 protrude more in the direction toward the driver than the lower ends thereof connected to the steering wheel 100. Here, the upper ends are disposed opposite the lower ends.

Surfaces of the first installation part 200 and the second installation part 300 facing the driver may be respectively defined as the front surface 210 of the first installation part 200 and the front surface 310 of the second installation part 300.

Each of the front surface 210 of the first installation part 200 and the front surface 310 of the second installation part 300 may be formed to have an inclined surface, in which the upper end of the inclined surface protrudes more toward the driver than the lower end thereof. Here, an angle A of the inclined surface may be formed as an angle between 90 degrees and 180 degrees with respect to a vertical extension line Li along which the handle part 110 of the steering wheel 100 extends.

In this manner, when the front surface 210 of the first installation part 200 and the front surface 310 of the second installation part 300 are formed as inclined surfaces, the acceleration control system 400 and the braking control system 500 provided at the first installation part 200, and the emergency light control system 600 and the direction indication control system 700 provided at the second installation part 300 are all disposed in the inclined direction so as to be located closer to the thumbs 21 and 31 of the right hand 20 and the left hand 30 of the driver. As a result, in a state in which the driver grips the handle part 110 of the steering wheel 100, the driver may easily and stably operate the braking control system 500, the acceleration control system 400, the emergency light control system 600, and the direction indication control system 700 with the thumbs 21 and 31 of the right hand 20 and the left hand 30.

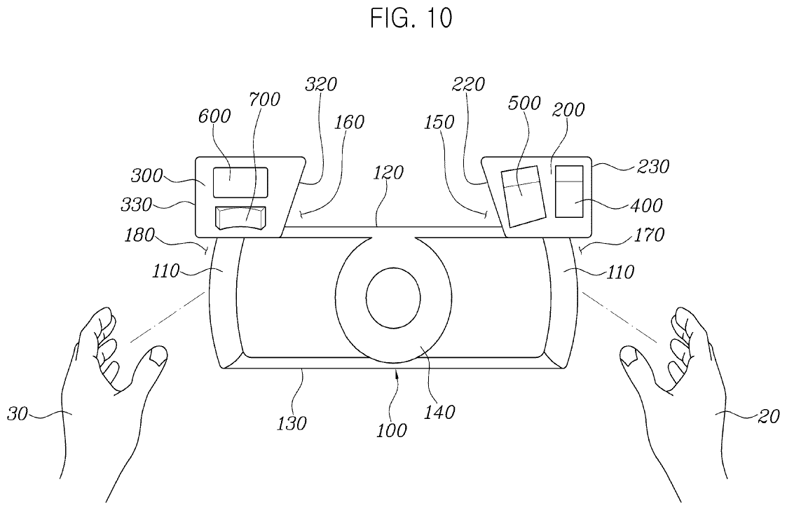

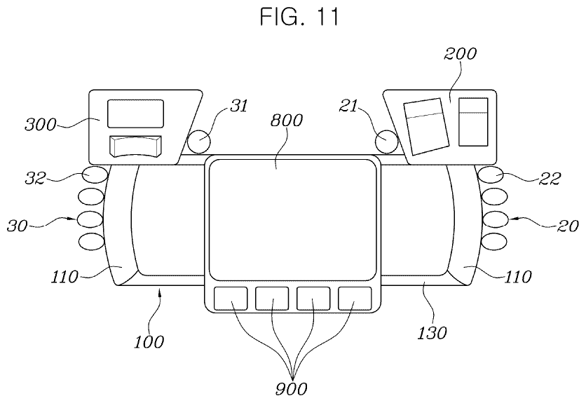

Referring to FIGS. 10 and 11, in the steering wheel 100, a first groove 150 formed by the upper connection part 120 and an inner side surface 220 of the first installation part 200 is formed at an acute angle, and the thumb 21 of the right hand 20 of the driver is inserted into the first groove 150 so as to perform the steering operation.

In addition, in the steering wheel 100, a second groove 160 formed by the upper connection part 120 and an inner side surface 320 of the second installation part 300 is formed at an acute angle, and the thumb 31 of the left hand 30 of the driver is inserted into the second groove 160 so as to perform the steering operation.

According to the present disclosure, a width in the left-and-right direction of the upper end of the first installation part 200 is formed to be longer than a width in the left-and-right direction of the lower end thereof. As a result, the first groove 150 formed by the upper connection part 120 and the inner side surface 220 of the first installation part 200 may be formed at an acute angle.

In a state in which the driver grips the right handle 110 with the right hand 20, the driver may perform the steering operation while inserting the thumb 21 of the right hand 20 into the first groove 150. Through this structural configuration, the right hand 20 may be prevented from being separated from the steering wheel 100 during steering operation, and steering operability may be particularly improved.

In addition, in the present disclosure, a width in the left-and-right direction of the upper end of the second installation part 300 is formed to be longer than a width in the left-and-right direction of the lower end thereof, and the second groove 160 formed by the upper connection part 120 and the inner side surface 320 of the second installation part 300 may be formed at an acute angle.

The first groove 150 and the second groove 160 may be formed to have the same angle so as to achieve symmetry in the left-and-right direction, but the present disclosure is not limited thereto.

In a state in which the driver grips the handle part 110 on the left side with the left hand 30, the driver may perform the steering operation while inserting the thumb 31 of the left hand 30 into the second groove 160. Through this structural configuration, the left hand 30 may be prevented from being separated from the steering wheel 100 during steering operation, and steering operability may be particularly improved.

Referring to FIGS. 10 and 11, in the steering wheel 100, an outer side surface 230 of the first installation part 200 protrudes farther outwards than the right handle part 110 of the steering wheel 100, thereby forming a third groove 170 between the outer side surface 230 of the first installation part 200 and the handle part 110 on the right side. Accordingly, an index finger 22 of the right hand 20 of the driver is inserted into the third groove 170 so as to perform the steering operation.

In addition, in the steering wheel 100, an outer side surface 330 of the second installation part 300 protrudes farther outwards than the left handle part 110 of the steering wheel 100, thereby forming a fourth groove 180 between the outer side surface 330 of the second installation part 300 and the handle part 110 on the left side. Accordingly, an index finger 32 of the left hand 30 of the driver is inserted into the fourth groove 180 so as to perform the steering operation.

The outer side surface 230 of the first installation part 200 is formed to protrude farther outwards than the handle part 110 on the right side in the radial direction. As a result, the third groove 170 having a concave shape may be formed between the outer side surface 230 of the first installation part 200 and the handle part 110 on the right side.

When the driver grips the handle part 110 on the right with the right hand 20, the index finger 22 of the right hand 20 is inserted into the third groove 170 so as to support the outer side surface 230 of the first installation part 200 from below. When the steering operation is performed in this state, the right hand 20 may be prevented from being separated from the steering wheel 100, and steering operability may be particularly improved.

In addition, the outer side surface 330 of the second installation part 300 is formed to protrude farther outwards than the handle part 110 on the left side in the radial direction. As a result, the fourth groove 180 having a concave shape may be formed between the outer side surface 330 of the second installation part 300 and the handle part 110 on the left side.

Each of the third groove 170 and the fourth groove 180 may be formed at an acute angle and may be formed at the same angle to form symmetry in the left-and-right direction, but the present disclosure is not limited thereto.

When the driver grips the left handle 110 with the left hand 30, the index finger 32 of the left hand 30 is inserted into the fourth groove 180 so as to support the outer side surface 330 of the second installation part 300 from below. When the steering operation is performed in this state, the left hand 30 may be prevented from being separated from the steering wheel 100, and steering operability may be particularly improved.

The vehicle driving control apparatus according to the present disclosure may further include a first connector 1000 coupled with a portion of the display 800 penetrating the steering wheel 100, a second connector 2000 fixed to the vehicle panel 10 and detachably coupled to the first connector 1000, and a locking guide 3000 movably provided on the vehicle panel 10 and configured to lock and unlock the first connector 1000 and the second connector 2000.

The portion of the display 800 is a cylindrical protrusion 810 that may be provided on the surface of the display 800 facing the front side of the vehicle, and the protrusion 810 of the display 800 may penetrate the center part 140 of the steering wheel 100 so as to be coupled to and integrated with the first connector 1000.

The first connector 1000 has a cylindrical outer shape, and one end of the first connector 1000 is coupled to the protrusion 810 of the display 800 in a male and female coupling manner.

The protrusion 810 of the display 800 and one end of the first connector 1000 are coupled to each other by screw coupling or snap fitting, thereby having a structure in which the display 800 and the first connector 1000 are integrated.

The first connector 1000 is coupled to the second connector 2000 fixed to the vehicle panel 10 in a detachable male and female structure.

In a case where the first connector 1000 and the second connector 2000 are coupled to each other, even if the driver performs the steering operation by rotating the steering wheel 100 clockwise or counterclockwise, the display 800 connected to the first connector 1000 does not rotate and maintains a fixed state thereof.

The vehicle driving control apparatus according to the present disclosure may further include a first permanent magnet 4000 provided at the steering wheel 100 and formed to face the first connector 1000, and a first PCB 5000 provided at the first connector 1000, formed to face the first permanent magnet 4000, and configured to generate, during rotation of the steering wheel 100, a steering signal by recognizing a signal of the first permanent magnet 4000.

A plurality of first permanent magnets 4000 are provided to be spaced apart from each other on one surface of the center part 140 of the steering wheel 100 through which the protrusion 810 of the display 800 penetrates, in which the one surface faces one end of the first connector 1000, and the first printed circuit board (PCB) 5000 is provided at one end of the first connector 1000, in which the one end faces the first permanent magnets 4000.

When the steering wheel 100 is rotated by the steering operation, the first PCB 5000 recognizes a change in magnetic flux depending on a change in position of the first permanent magnets 4000 and transmits a steering signal to a vehicle-side controller.

The vehicle driving control apparatus according to the present disclosure may further include a steering spring 6000 having opposite ends respectively connected to the steering wheel 100 and the first connector 1000 and configured to provide return force during rotation of the steering wheel 100.

The steering spring 6000 may be formed of a coil spring. One end of the steering spring 6000 may be coupled to the center part 140 of the steering wheel 100, and the other end thereof may be coupled to the first connector 1000.

Additionally, a plurality of steering springs 6000 may be provided for safety.

When the steering wheel 100 is rotated to perform the steering operation, the steering spring 6000 accumulates elastic force while being compressed or tensioned, and when operating force from the driver is released from the steering wheel 100, the shape of steering wheel 100 is restored, thereby returning the steering wheel 100 to the neutral position.

The acceleration control system 400 and the braking control system 500 according to the present disclosure may be respectively formed as button types each having the same structure and may be operated by allowing the driver to press the same with the thumb 21 of the right hand 20.

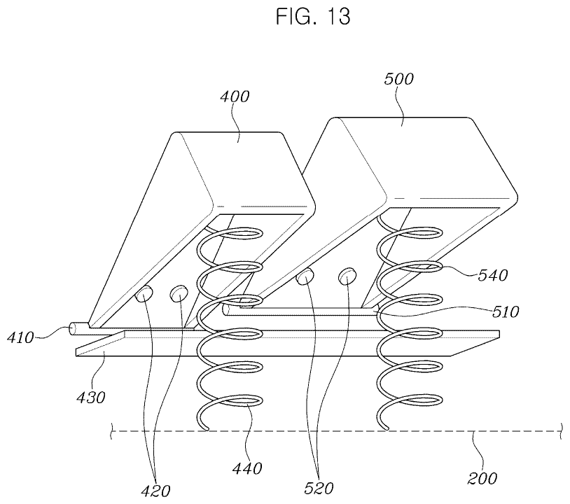

Referring to FIG. 13, the acceleration control system 400 and the braking control system 500 respectively have hinge parts 410 and 510 disposed at the lower ends thereof. When the driver operates the acceleration control system 400 and the braking control system 500 by pressing the same with the thumb 21 of the right hand 20, the upper ends of the acceleration control system 400 and the braking control system 500 may be respectively rotated around the lower hinge parts 410 and 510.

Plural second permanent magnets 420 and plural third permanent magnets 520 are respectively provided on the bottom surfaces of the acceleration control system 400 and the braking control system 500. The first installation part 200 may have a second PCB 430 fixedly provided thereon and configured to face the second permanent magnets 420 and the third permanent magnets 520.

The first PCB 5000 and the second PCB 430 may be configured individually or may be integrated into one PCB.

When the driver operates the acceleration control system 400, the second PCB 430 may recognize a change in magnetic flux depending on a change in position of each of the second permanent magnets 420 and may transmit an acceleration signal to the vehicle-side controller. When the driver operates the braking control system 500, the second PCB 430 may recognize a change in magnetic flux depending to a change in position of each of the third permanent magnets 520 and may transmit a braking signal to the vehicle-side controller.

In addition, opposite ends of an acceleration spring 440 are installed to be supported between the acceleration control system 400 and the first installation part 200, and opposite ends of a braking spring 540 are installed to be supported between the braking control system 500 and the first installation part 200. In this manner, the acceleration control system 400 and the braking control system 500 may be restored by spring force.

The return position (or initial position) and full stroke position of the acceleration control system 400 are regulated by contact between the acceleration control system 400 and the first installation part 200, and the regulation position may be set to various positions through tuning.

In addition, regulation of the return position (or initial position) and full stroke position of the braking control system 500 may be set by contact between the braking control system 500 and the first installation part 200. This configuration is the same as that of the acceleration control system 400, but the present disclosure is not limited thereto.

According to the present disclosure, a connector protrusion 1100 is formed to protrude from the end of the first connector 1000. Here, the connector protrusion 1100 penetrates a connector hole 11 formed in the vehicle panel 10 and is inserted into a connector groove 2100 formed in the second connector 2000. In a state in which the connector protrusion 1100 is inserted into the connector groove 2100, when the locking guide 3000 is coupled to the connector protrusion 1100, the first connector 1000 and the second connector 2000 may be prevented from being separated from each other and may maintain a coupled state therebetween.

The locking guide 3000 according to the present disclosure is installed to slidably move, by using a guide spring 7000, upwards and downwards relative to the vehicle panel, and the connector hole 11 formed in the vehicle panel 10 is partially covered by the locking guide 3000 and is fully opened only when the locking guide 3000 moves. Here, only when the connector hole 11 is fully opened, the connector protrusion 1100 may penetrate the connector hole 11 so as to be inserted into and coupled to the connector groove 2100.

The locking guide 3000 according to the present disclosure is installed to slidably move upwards and downwards relative to the vehicle panel 10 and has wing parts 3100 provided at the end thereof and formed to extend in the longitudinal direction. The connector protrusion 1100 has locking grooves 1200 respectively formed in the side surfaces thereof and configured to allow the wing parts 3100 to be respectively inserted thereinto, in which each of the locking grooves 1200 is formed to extend in the movement direction of the locking guide 3000. Here, when the wing parts 3100 are respectively inserted into the locking grooves 1200 by movement of the locking guide 3000, the first connector 1000 and the second connector 2000 may maintain a coupled state therebetween while preventing separation therebetween.

Two wings 3100 are formed at the upper end of the locking guide 3000 and are spaced apart from each other in the left-and-right direction, and the locking grooves 1200 into which the two wings 3100 are respectively inserted are formed on the left and right sides of the connector protrusion 1100.

The locking guide 3000 is installed to be supported by the vehicle panel 10 using the guide spring 7000. Here, when a user does not operate the locking guide 3000, the locking guide 3000 maintains an upward movement state thereof by elastic force of the guide spring 7000. At this time, the two wings 3100 cover a part of the connector hole 11 formed in the vehicle panel 10.

In a state in which the connector hole 11 is partially covered by the wing parts 3100, the connector protrusion 1100 of the first connector 1000 may not penetrate the connector hole 11 and thus may not be coupled to the connector groove 2100 formed in the second connector 2000.

When a user slidably moves the locking guide 3000 downwards, the wing parts 3100 are separated from the connector hole 11 and the connector hole 11 is fully opened. In this state, the connector protrusion 1100 penetrates the connector hole 11 so as to be coupled to the connector groove 2100.

After the connector protrusion 1100 and the connector groove 2100 are coupled to each other, when the user releases the locking guide 3000, the locking guide 3000 moves upwards and returns to the initial position thereof by elastic force of the guide spring 7000. Here, the two wing parts 3100 are respectively inserted into the locking grooves 1200 of the connector protrusion 1100. As a result, the first connector 1000 and the second connector 2000 are prevented from being separated from each other by the locking guide 3000, thereby maintaining a coupled state therebetween.

Each of the wing parts 3100 is formed to have a structure in which the lower end has a larger cross-sectional thickness than that of the upper end, and the cross-sectional thickness gradually becomes thinner from the lower end to the upper end. When the wing parts 3100 are completely inserted into the locking groove 1200, the wing parts 3100 and the locking grooves 1200 may maintain a more stable coupled state therebetween by the cross-sectional thickness of each of the wing parts 3100.

In addition, when one ends of the wing parts 3100, each of the one ends having a thin cross-sectional thickness, respectively slide into the locking grooves 1200 at the beginning of insertion, the one ends are aligned with the locking grooves 1200 while absorbing a gap therebetween, thereby performing smooth coupling therebetween.

Further, the vehicle panel 10 may have guide parts 12 formed thereon and configured to guide movement of the two wing parts 3100 when the locking guide 3000 slides.

According to the present disclosure, the locking guide 3000 further has a locking hook 3200 formed thereon, and the first connector 1000 has a hook groove 1300 formed therein and configured to allow the locking hook 3200 to be inserted thereinto. When the wing parts 3100 and the locking groove 1200 are coupled to each other, the locking hook 3200 and the hook groove 1300 are also coupled to each other, thereby making it possible to strengthen the coupled state between the first connector 1000 and the second connector 2000.

The locking guide 3000 has the two wing parts 3100 formed at the upper end thereof, and the locking hook 3200 is disposed below the wing parts 3100 and is formed to protrude upwards.

The first connector 1000 may have the connector protrusion 1100 formed to protrude from the center portion of one end thereof, and the hook groove 1300 may be formed in an edge portion below the connector protrusion 1100 in a concave shape indented toward the center portion of the first connector 1000.

Therefore, when the wing parts 3100 of the locking guide 3000 are respectively inserted into and coupled to the locking grooves 1200 of the connector protrusion 1100, the locking hook 3200 of the locking guide 3000 is also inserted into and coupled to the hook groove 1300 of the first connector 1000, thereby further strengthening coupling force between the first connector 1000 and the second connector 2000.

Furthermore, according to the present disclosure, the first connector 1000 has an arc-shaped guide protrusion 1400 provided at one end thereof and formed to protrude in the longitudinal direction thereof, and the vehicle panel 10 has an arc-shaped guide groove 13 formed therein and configured to allow the guide protrusion 1400 to be inserted thereinto. Here, when the connector protrusion 1100 penetrates the connector hole 11 so as to be coupled to the connector groove 2100, the guide protrusion 1400 and the guide groove 13 are also coupled to each other so as to strengthen coupling force between the first connector 1000 and the second connector 2000.

The first connector 1000 has the arc-shaped guide protrusion 1400 provided at one end thereof, disposed along the circular edge thereof, and formed to protrude in the longitudinal direction thereof.

In the vehicle panel 10, the guide groove 13 having the same arc shape as that of the guide protrusion 1400 is formed to have an inwardly concave cross section.

The arc-shaped guide groove 13 may be formed to surround the periphery of the connector hole 11.

Therefore, when the connector protrusion 1100 of the first connector 1000 penetrates the connector hole 11 of the vehicle panel 10 so as to be coupled to the connector groove 2100 of the second connector 2000, the guide protrusion 1400 of the first connector 1000 is also inserted into and coupled to the guide groove 13 of the vehicle panel 10, thereby further strengthening coupling force between the first connector 1000 and the second connector 2000.

As described above, according to the embodiments of the present disclosure, it is possible to simultaneously perform, when the steering wheel 100 is coupled to the vehicle panel 10, first coupling between the connector protrusion 1100 and the connector groove 2100, second coupling between the wing parts 3100 of the locking guide 3000 and the locking groove 1200 of the connector protrusion 1100, third coupling between the locking hook 3200 of the locking guide 3000 and the hook groove 1300 of the first connector 1000, and fourth coupling between the guide protrusion 1400 of the first connector 1000 and the guide groove 13 of the vehicle panel 10. Through the four coupling procedures, movement of the steering wheel 100 coupled to the vehicle panel 10 may be prevented. In particular, coupling force of the steering wheel 100 may be further strengthened, thereby preventing the steering wheel 100 from being unintentionally separated from the vehicle panel 10.

As described above, the vehicle driving control apparatus according to the present disclosure has a modular configuration in which the steering wheel 100, the acceleration control system 400, the braking control system 500, the emergency light control system 600, the direction indication control system 700, the display 800, and the shift control system 900 are integrated into one system. Through the modular configuration, it is possible to reduce the number of parts and to achieve weight reduction and cost reduction. Particularly, the size of a layout area for an installation space may be maximally reduced, thereby having an effect of maximally improving utilization of a vehicle interior space.

Further, in the vehicle driving control apparatus according to the present disclosure, the steering wheel 100 is used by being coupled to the vehicle panel 10 in the manual driving mode, and the steering wheel 100 may be removed from the vehicle panel 10 in the autonomous driving mode, thereby having an effect of maximally improving utilization of a vehicle interior space in the autonomous driving mode.

Furthermore, in the vehicle driving control apparatus according to the present disclosure, the display 800 does not rotate and maintains the fixed position thereof even when the steering wheel 100 is rotated by a steering operation. Particularly, the display 800 is located closer to a driver than the steering wheel 100, thereby preventing the screen from being blocked by the steering wheel 100. In this manner, there is an advantage in that the driver may look at the display 800 more stably and comfortably.

As is apparent from the above description, the present disclosure provides a vehicle driving control apparatus having a modular configuration obtained by integrating a steering wheel, an acceleration control system, a braking control system, an emergency light control system, a direction indication control system, a display, and a shift control system into one system. Through this modular configuration, it is possible to reduce the number of parts and to achieve weight reduction and cost reduction. Particularly, the size of a layout area for an installation space is maximally reduced, thereby having an effect of maximally improving utilization of a vehicle interior space.

Additionally, the vehicle driving control apparatus provides a manual driving mode and an autonomous driving mode. Here, in the manual driving mode, the steering wheel is used by being coupled to a vehicle panel, and in the autonomous driving mode, the steering wheel may be removed from the vehicle panel, thereby having an effect of maximally improving utilization of a vehicle interior space in the autonomous driving mode.

Furthermore, in the vehicle driving control apparatus, the display does not rotate and maintains the fixed position thereof even when the steering wheel is rotated by a steering operation. Particularly, the display is located closer to a driver than the steering wheel such that the screen is prevented from being blocked by the steering wheel, thereby having an effect of enabling the driver to look at the display more stably and comfortably.

Although the implementations of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A vehicle driving control apparatus comprising:
a steering wheel configured to be gripped by a driver and to perform a steering operation based on being rotated by the driver;
a first installation part disposed at a first upper end corner portion of the steering wheel;
a second installation part disposed at a second upper end corner portion of the steering wheel;
an acceleration control system disposed at the first installation part; and
a braking control system disposed at the first installation part.

2. The vehicle driving control apparatus of claim 1, further comprising:
an emergency light control system disposed at the second installation part; and
a direction indication control system disposed at the second installation part.

3. The vehicle driving control apparatus of claim 1, further comprising a display disposed at a center portion of the steering wheel and configured to maintain a fixed state during rotation of the steering wheel,
wherein the display comprises a screen that is disposed closer to the driver than the steering wheel to thereby provide access to the screen without being blocked by the steering wheel.

4. The vehicle driving control apparatus of claim 3, further comprising a shift control system disposed at the display.

5. The vehicle driving control apparatus of claim 3, wherein the steering wheel comprises:
handle parts that are respectively disposed at left and right sides of the steering wheel and symmetrically arranged at the left and right sides of the steering wheel, wherein each of the handle parts has a circular arc shape protruding outward and is configured to be gripped by the driver;
an upper connection part that connects upper ends of the handle parts to each other and has corner portions respectively connected to the handle parts, wherein the first installation part and the second installation part are respectively disposed at the corner portions of the upper connection part;
a lower connection part that connects lower ends of the handle parts to each other; and
a center part that is disposed at a center portion between the handle parts and connects the upper connection part to the lower connection part, wherein at least a portion of the display passes through the center part.

6. The vehicle driving control apparatus of claim 1, wherein the braking control system is disposed on a left side of the acceleration control system and has a larger external size than an external size of the acceleration control system,
wherein the braking control system protrudes outward from the first installation part and defines a first height from the first installation part, and
wherein the acceleration control system protrudes outward from the first installation part and defines a second height from the first installation part, wherein the first height is greater than the second height.

7. The vehicle driving control apparatus of claim 2, wherein the direction indication control system is disposed below the emergency light control system and disposed closer to a hand of the driver than the emergency light control system.

8. The vehicle driving control apparatus of claim 1, wherein the first installation part and the second installation part respectively have inclined front surfaces,
wherein each of the inclined front surfaces has an upper end protruding further in a direction toward the driver than a lower end thereof.

9. The vehicle driving control apparatus of claim 5, wherein the first installation part has a first inner side surface that defines a first groove with the upper connection part, the first inner side surface defining an acute angle with respect to the upper connection part,
wherein the first groove is configured to receive a thumb of a right hand of the driver during the steering operation,
wherein the second installation part has a second inner side surface that defines a second groove with the upper connection part, the second inner side surface defining an acute angle with respect to the upper connection part, and
wherein the second groove is configured to receive a thumb of a left hand of the driver during the steering operation.

10. The vehicle driving control apparatus of claim 5, wherein the handle parts comprise a right handle part and a left handle part that are respectively disposed at the left and right sides of the steering wheel,
wherein the first installation part has a first outer side surface that protrudes outward relative to the right handle part and that defines a third groove between the first outer side surface of the first installation part and the right handle part,
wherein the third groove is configured to receive an index finger of a right hand of the driver during the steering operation,
wherein the second installation part has a second outer surface that protrudes outward relative to the left handle part and that defines a fourth groove between the second outer surface of the second installation part and the left handle part, and
wherein the fourth groove is configured to receive an index finger of a left hand of the driver during the steering operation.

11. The vehicle driving control apparatus of claim 3, further comprising:
a first connector that is coupled to a portion of the display, wherein the portion of the display is configured to pass through the steering wheel;
a second connector configured to be fixed to a vehicle panel and detachably coupled to the first connector; and
a locking guide movably disposed at the vehicle panel and configured to lock and unlock the first connector and the second connector.

12. The vehicle driving control apparatus of claim 11, further comprising:
a first permanent magnet that is disposed at the steering wheel and faces the first connector; and
a first printed circuit board (PCB) that is disposed at the first connector and faces the first permanent magnet,
wherein the first PCB is configured to, during rotation of the steering wheel, generate a steering signal by recognizing a signal of the first permanent magnet.

13. The vehicle driving control apparatus of claim 11, further comprising a steering spring having opposite ends respectively connected to the steering wheel and the first connector, the steering spring being configured to provide return force to the steering wheel during rotation of the steering wheel.

14. The vehicle driving control apparatus of claim 11, wherein the first connector comprises a connector protrusion that protrudes from an end thereof,
wherein the second connector defines a connector groove that receives the connector protrusion,
wherein the connector protrusion is configured to pass through a connector hole of the vehicle panel and be inserted into the connector groove of the second connector, and
wherein the first connector and the second connector are configured to maintain a coupled state based on the locking guide being coupled to the connector protrusion in a state in which the connector protrusion is inserted into the connector groove.

15. The vehicle driving control apparatus of claim 14, further comprising a guide spring disposed at the locking guide and configured to guide the locking guide to slidably move upward and downward relative to the vehicle panel,
wherein the locking guide is configured to cover at least a part of the connector hole of the vehicle panel, the locking guide being configured to fully open the connector hole based on movement of the locking guide, and
wherein the connector protrusion is configured to pass through the connector hole based on the connector hole being fully opened, and to be inserted into and coupled to the connector groove.

16. The vehicle driving control apparatus of claim 14, wherein the locking guide is configured to slidably move upward and downward relative to the vehicle panel, the locking guide comprises wing parts that are disposed at an end of the locking guide and extend in a longitudinal direction of the locking guide,
wherein the connector protrusion defines locking grooves at side surfaces thereof, the locking grooves being configured to receive the wing parts respectively, wherein each of the locking grooves extending in a movement direction of the locking guide, and
wherein the first connector and the second connector are configured to maintain the coupled state based on the wing parts being respectively inserted into the locking grooves by movement of the locking guide.

17. The vehicle driving control apparatus of claim 16, wherein the locking guide further comprises a locking hook,
wherein the first connector defines a hook groove configured to receive the locking hook, and
wherein the locking hook and the hook groove are configured to be coupled to each other based on the wing parts and the locking grooves being coupled to each other.

18. The vehicle driving control apparatus of claim 17, wherein the first connector has a guide protrusion that is disposed at a first end of the first connector and has an arc shape, the guide protrusion protruding in a longitudinal direction of the first connector being configured to be inserted into a guide groove that is defined at the vehicle panel and has an arc-shape, and
wherein the guide protrusion and the guide groove are configured to be coupled to each other based on the connector protrusion passing through the connector hole and being coupled to the connector groove.

19. The vehicle driving control apparatus of claim 11, wherein the portion of the display includes a protrusion disposed at a surface of the display that faces a front side of a vehicle, and
wherein the protrusion of the display passes through the center portion of the steering wheel and is coupled to the first connector.

20. The vehicle driving control apparatus of claim 16, wherein each of the wing parts has a lower end and an upper end disposed above the lower end, and
wherein a cross-sectional thickness of each of the wing parts decreases from the lower end to the upper end.
